(19) United States
(12) Patent Application Publication
(10) Pub. No.: US 2026/0257524 A1
(43) Pub. Date: Sep. 3, 2026

(54) Coupling device for supply lines, in particular for conveying media from a tractor to a semi-trailer

(71) Applicant: ALLIGATOR AG, Rotkreuz (CH)

(72) Inventor: Michael Schacher

(73) Assignee: ALLIGATOR AG, Rotkreuz (CH)

(21) Appl. No.: 18/846,755

(22) PCT Filed: Mar. 15, 2023
(86) PCT No.: PCT/EP2023/056593

§ 371 Date: Sep. 13, 2024

(30) Foreign Application Priority Data
Mar. 16, 2022 (CH) 282/2022

(51) Int. Cl. B60D 1/64; B62D 53/08

(52) U.S. Cl. CPC B60D 1/64; B62D 53/0842

(57) ABSTRACT

A coupling device for supply lines is used in particular for conveying media from a tractor to a semi-trailer (11) or vice versa. The tractor and the semi-trailer (11) can be coupled and uncoupled by means of a coupling unit (10), which comprises a fifth wheel coupling (15) on the tractor and a support element (22′) with a king pin (21) on the semi-trailer (11). Below the fifth wheel coupling (15) and below the king pin (21), there is at least one coupling block (30, 31) each, the coupling blocks each being provided with a plurality of connector elements (37, 38, 77, 78) for connecting the supply lines (33, 34, 35, 36). A rotary element (20) disposed in the support element is provided, to which rotary element the at least one coupling block (30, 31) and a centering device (25) are fastened. During the coupling, the centering device interacts with centering means on the fifth wheel coupling (15) such that the coupling blocks (30, 31) can be aligned with each other and consequently can be connected to each other. The supply lines (35, 36) leading away from the coupling block (31) on the semi-trailer (11) are led, by connecting means (23, 24) in the rotary element (20), to the supply lines (35′, 36′) disposed in the semi-trailer (11). With said coupling device for said supply lines in particular for exchanging said media, a very compact construction has been achieved which allows the supply lines to be automatically connected when the fifth wheel coupling is coupled to the king pin.

The invention relates to a coupling device for supply lines, in particular for conveying media from a tractor to a semi-trailer or vice-versa, which can be coupled or uncoupled by means of a coupling unit, which comprises a fifth-wheel coupling on the tractor and a support element with a kingpin on the semi-trailer, in accordance with the preamble to claim 1.

On tractor-trailer combinations, the semi-trailer is coupled to the tractor by means of a fifth-wheel coupling. The fifth-wheel coupling essentially comprises a fifth-wheel coupling plate with a closure device on the tractor, and what is referred to as a king pin on the semi-trailer. In addition to this, connections, in particular electrical, pneumatic, and/or hydraulic are coupled between the tractor and the semi-trailer. These connections are usually connected manually by means of flexible lines. This is an elaborate and time-consuming task for the driver during the coupling and uncoupling of the tractor-trailer combination.

According to the printed publication U.S. Pat. No. 9,085,208, the principle is further known of providing in particular means for transferring electrical energy from an electrical system of a vehicle into that of a trailer. The trailer has a sliding plate arranged horizontally, with a king pin extending centerally downwards, wherein a ring-shaped electrical contact provider is located on the lower surface of this sliding plate, which is connected to the electrical system of the trailer. The fifth-wheel coupling comprises a longitudinal electrical contact element which corresponds to the electrical contact provider on the trailer, and which is positioned at the front end of a support plate of the fifth-wheel coupling on the vehicle. This electrical contact element comprises a plurality of electrical contacts, spaced apart from one another, which can be electrically connected on the one hand to the on-board network of the vehicle and, on the other, to the contacts of the contact provider on the sliding plate. Such an electrical coupling is provided when the king pin is pushed into the receiving opening of the fifth-wheel coupling and locked in place. The disadvantage with this system is that the electrical contact provider on the trailer and the contact element with the plurality of contacts on the vehicle are poorly protected against the effects of the weather during the coupling or uncoupling of the vehicle to or from the trailer, and undesirable damage is incurred which can lead to malfunctions.

The invention is based on the object of improving a coupling device for supply lines, in particular for conveying media from a tractor to a semi-trailer or vice-versa, in such a way that, making use of this, reliable coupling and uncoupling, in particular which can be automated, can be achieved with a structural design which is robust and capable of resisting rough operating conditions.

This object is solved according to the invention by the features of claim 1.

Below the fifth-wheel coupling and the king pin there is one coupling block each, the coupling blocks each being provided with a plurality of connector elements for connecting the supply lines. The at least one coupling block and a centering device are secured to a rotary element, this being arranged in the support element of the semi-trailer, which interact during the coupling with centering means on the fifth-wheel coupling in such a way that the coupling blocks can be aligned with one another and can subsequently be connected. Moreover, according to the invention the supply lines leading away from the coupling block on the semi-trailer are guided through connecting means in the rotary element to the supply lines arranged in the semi-trailer.

It is very advantageous for this centering device to be secured beneath the rotary element on the trailer, and the coupling block beneath that, wherein the supply lines are guided by the centering device into the rotary element and from this into the semi-trailer.

With this coupling device according to the invention for supply lines, in particular for the exchanging of media between a tractor unit and a semi-trailer, a very compact structural design has been achieved, which allows for an automatic connection of the supply lines during the coupling of the fifth-wheel coupling to the king pin. The media being conveyed involve, in particular electrical energy or electrical signals, or pneumatic and/or hydraulic energy or signals, which are sent from the tractor unit to the semi-trailer or vice-versa.

According to the invention, this rotary element comprises at least one base element which can be secured in a semi-trailer, and, mounted in this, a slip-ring packet, by means of which the supply lines can be connected for the conveying of energy to the semi-trailer.

By means of this rotary element, an extremely secure and reliable functioning connection of the supply lines is achieved.

The invention and its further advantages are explained in greater detail hereinafter on the basis of exemplary embodiments and by making reference to the drawings. The Figures show:

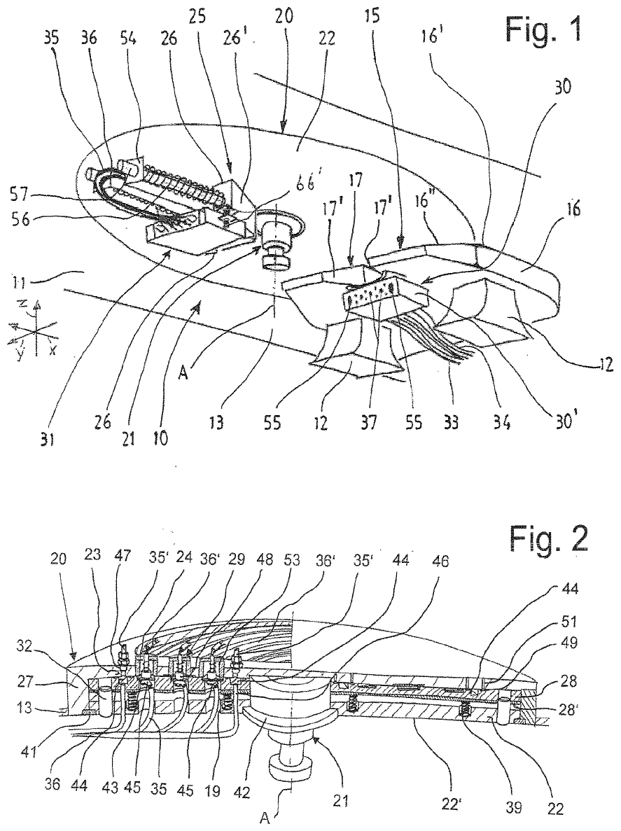

FIG. 1 is a schematic perspective view of a coupling unit for the coupling and uncoupling of a tractor to and from a semi-trailer, and a coupling device according to the invention for supply lines, in each case in the uncoupled state;

FIG. 2 is a schematic transverse section through a rotary element with a king pin beneath the semi-trailer;

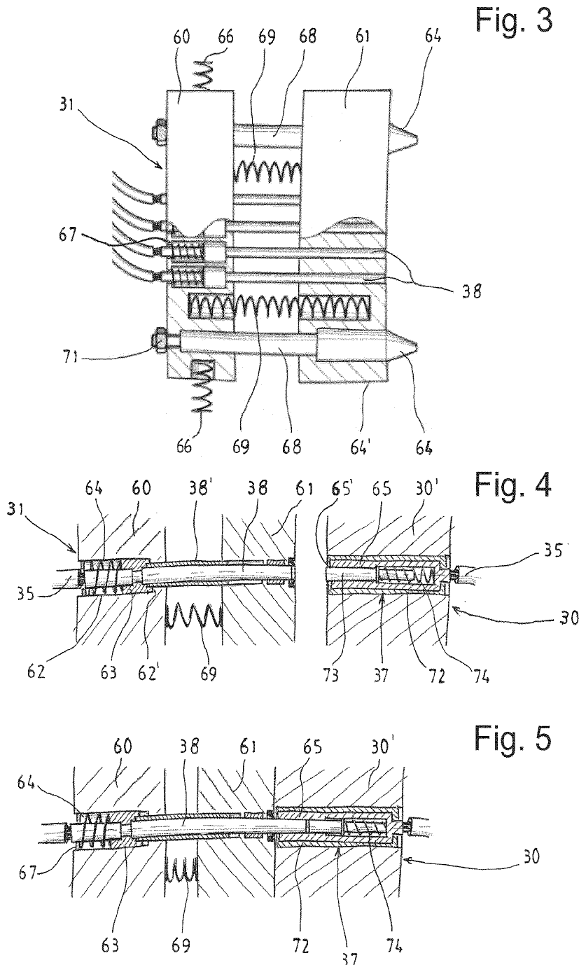

FIG. 3 is a view from above, with a partial section of the coupling block on the semi-trailer according to FIG. 1;

FIG. 4 is a part sectional view of the coupling blocks according to FIG. 1, with electrical connector elements in the uncoupled state;

FIG. 5 is a part sectional view of the coupling blocks with the electrical connector elements according to FIG. 4, in the coupled state;

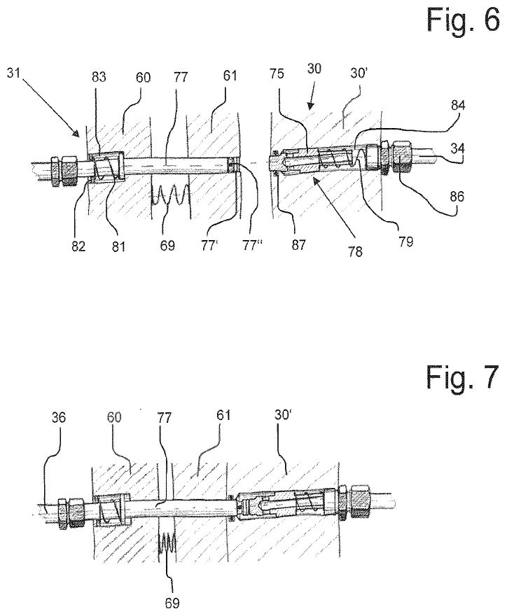

FIG. 6 is a part sectional view of the coupling blocks according to FIG. 1, with connector elements for conveying a medium, in the uncoupled state;

FIG. 7 is a part sectional view of the coupling blocks with the connector elements according to FIG. 6, in the coupled state; and

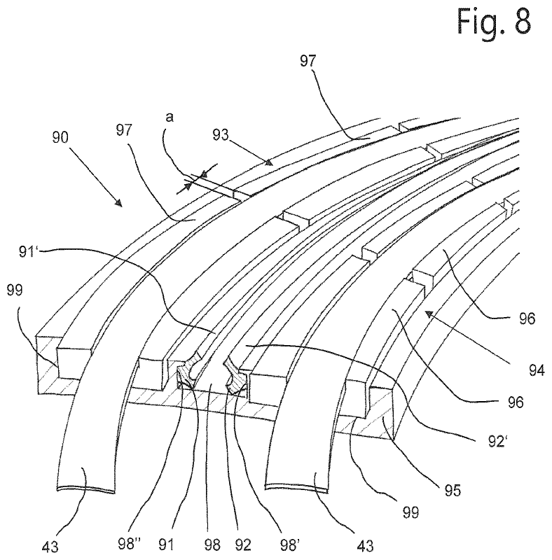

FIG. 8 is a partial perspective view from above, with a part sectional view of a variant of an isolation plate of the rotary element of the device according to FIG. 1.

FIG. 1 shows a schematic view of a coupling unit 10 for the coupling and uncoupling of a tractor unit with a semi-trailer 11, which comprises a fifth-wheel coupling 15 on the top side, with the wheel axles of the tractor unit, not shown in any greater detail, and a king pin 21 on the under side on the semi-trailer 11. The arrangement and configuration of this coupling unit 10 can of course be different depending on the model or manufacturer of the tractor unit and the trailer. It is used in particular on road vehicles for the transport of goods of all kinds, livestock, etc., or as working machines. In principle, it could also involve rail vehicles.

The fifth-wheel coupling 15 is provided with an upper plate 16, comprising a conical slot opening 17 on the rear, which is secured to a retaining element 12 or the like. During coupling, the tractor unit is reversed under the semi-trailer 11, such that the fifth-wheel coupling 15, with its conical slot opening 17, engages into the shaft-shaped king pin 21, and is driven in this slot opening 17 as far as an end stop and then locked. A support plate 22 of the semi-trailer 11, located on the under side of the floor wall 13, which surrounds the king pin 21, is located in the coupled state on an upper contact surface 16′ of the plate 16 of the fifth-wheel coupling 15. Starting from this upper contact surface 16′, the plate 16 is preferably configured on the rear with an oblique element 16″, such that tolerances can be accommodated during the coupling procedure, and this plate 16 can be reliably moved underneath the support plate 22 of the semi-trailer 11.

Projecting approximately radially away from the king pin 21, and arranged behind it, is a centering device 25, beneath the support element 22′ of the semi-trailer 11. In the coupled state, projecting wedge-shaped centering means 26 engage in wedge fashion on the front side of this centering device 25, in this conical slot opening 17 of the fifth-wheel coupling 15, inasmuch as they are pressed with their wedge surfaces 26′ by spring elements 56 onto the flanks 17′ of the slot opening 17 in the plate 16. This centering device 25 is rotatably mounted on a support plate 22, about the axis of rotation A of the king pin 21 secured to the semi-trailer 11, and is therefore always aligned with its longitudinal extension in the direction of travel of the tractor unit. These wedge-shaped centering means 26, and the spring elements 56, are each guided by a guide element 54 in a rod 57, through which the supply lines 35, 36 are preferably guided, in a protected manner. It would also be possible for only one guide element and one spring element to be provided, wherein the respective spring element is configured as a helical spring, plate spring, leaf spring, or the like. With the use of leaf springs, they could by analogy be placed instead of the guide elements and the wedges, and during coupling they are guided directly into this conical slot opening 17 of the fifth-wheel coupling 15.

Moreover, a coupling device is assigned to the coupling unit 10, for the supply lines 33, 34, 35, 36, in particular for conveying media from the tractor unit to the semi-trailer 11 or vice-versa. These media involve electrical, pneumatic, and/or hydraulic energy. In this situation, compressed air, oil, water and/or other media can be used, which can be conveyed in a controlled manner by drive elements in the tractor unit or in the semi-trailer 11, from one to the other, which can be batteries, generators, hydraulic or pneumatic pumps, pressure vessels, or the like, to which the supply lines 33, 34, 35, 36 are connected. The supply and conveying of the media can also be put into effect, depending on the function, by the transfer of electrical signals or even by pneumatic or hydraulic control pulses.

According to the invention, in each case a coupling block 30, 31 is assigned on the under side to the fifth-wheel coupling 15 and to the king pin 21, which in each case are provided with preferably a plurality of connector elements 37, 38, for connecting the supply lines 33, 34, 35, 36, wherein a rotary element 20 is provided, arranged on the under side of the semi-trailer 11, secured to which are at least one coupling block 31 and the centering device 25. During coupling, the centering device 25 interacts with the centering means 26 at the fifth-wheel coupling 15 in such a way that the coupling blocks 30, 31, can be aligned with one another, and, in consequence, their connector elements 37, 38, 77, 78 can be plugged into and connected with one another. This makes it possible, during coupling of the tractor unit to the semi-trailer 11, for the coupling blocks 30, 31, to be automatically coupled, or automatically uncoupled when the tractor-trailer combination is separated.

Moreover, according to the invention, the supply lines 35, 36, leading away from the coupling block 31 on the semi-trailer 11, are guided through connecting means 23, 24, in the rotary element 20 to the supply lines 35′, 36′ arranged in the semi-trailer 11.

According to FIG. 2, provided in the rotary element 20 are at least one base element 27, secured in the floor wall 13 of the semi-trailer 11, and rotatably mounted in that is a slip-ring packet 29, with the connection means 23, 24, which connects in an energy transferring manner the supply lines 33, 34, 35, 36, of the tractor unit, via the coupling blocks 30, 31, to those lines leading to the consuming components on the semi-trailer 11. Rotatably mounted in the pot-shaped base element 27 of the rotary element 20 is an isolation plate 28, which is at least partially not electrically conductive, with the slip-ring packet 29, a stabilizing plate 28′ arranged beneath that, and the lower support plate 22. This isolation plate 28, the stabilizing plate 28′, and the support plate 22, are rotatably connected to one another by means of at least one positioning element 32, such as, for example, by bolts. In addition, the isolating plate 28, together with the stabilizing plate 28′ are pressed against the base element 27 by spring elements 39, which are held in the support plate 22. Accordingly, a permanent seal is ensured between the base element 27 and the isolating plate 28. The respective spring element 39 is configured as a helical spring, plate spring, leaf spring, or the like.

This isolating plate 28 is advantageously produced from a material with good sliding properties, such as, for example, a plastic such as PTFE or the like, in order for it to be mounted permanently in the base element 27 with low sliding friction. The base element 27 is very advantageously coated in particular with chrome on its contact surface with the isolating plate 28, in order for the sliding properties between these two elements to be permanently ensured. Moreover, the base element 27 is produced as one piece or from a plate and a ring, such as is illustrated on the right side of the sectional view in FIG. 2.

The support plate 22 is supported on the outside on a bearing ring 41 in the base element 27, as indicated, and in the center on a hub 42 of the king pin 21 secured to the base element 27. The supply lines 35, 36, are guided through transverse boreholes 19 in the support plate 22, which are sealed with a sealing material, not shown in any greater detail, in order for the support plate 22 to serve as a closure cover for the base element 27. As an alternative, the king pin 21 could be secured in the semi-trailer, and in this situation can extend through the base element or could be screwed on the under side to a separate retaining element contained in the base element, wherein this retaining element would be provided with the hub (42), although this is not illustrated in any greater detail.

The slip-ring packet 29 with the connecting means 23, 24 preferably comprises a plurality of ring grooves 44, arranged coaxially at a distance from one another, and slip rings 43 with connections 45, 46 on the inlet side for the supply lines 35, 36 leading away from the coupling block 31, and also connector elements 47 and sliding contacts 48 in the base element 27. These connector elements 47 form in each case a passage opening from the ring groove 44 to the supply line 35′, while in each case electric current is conducted through the electrically conductive sliding contacts 48, which are each protected by an isolator 53, to the supply line 36′, and from this to a consuming component in the semi-trailer 11 or vice-versa. A ring groove 44 is provided in each case on the inside and outside, arranged between three slip-rings 43 at a distance from one another. It would of course be possible for the number and arrangement of the ring grooves and the slip rings of this slip-ring packet 29 to be varied, depending on the circumstances of the consuming components or of the drive elements in the trailer. It would also be possible for only one slip ring or ring groove to be provided, or only a slip ring or a ring groove.

Further provided, as a pressure equalization device on both sides of the ring grooves 44, is in each case a ring-shaped cut-out opening 49, and at least one transverse borehole 51 leading from this through the base element 27, by means of which a build-up of pressure can be prevented between the isolation plate 28 and the base element 27, in particular in the event of a leak, and the possibility of a gap forming between these, due to which the sealing of the connecting means 23 would no longer be ensured.

The invention is therefore characterized by this compact arrangement of the coupling device, wherein provision is made for this rotary element 20, at the support element, with the centering device 25 secured beneath it, and the coupling block 31 beneath that, as well as the supply lines 35, 36, guided from the coupling block through the centering device 25 into the rotary element 20, and from this into the semi-trailer 11. Due to the low structural height of the coupling blocks 30, 31, configured in a box shape, this slim structural design is additionally advantageous.

When the tractor unit is driven, the centering device 25 is always aligned in the direction of travel by the fifth-wheel coupling 15. In the event of a change of direction, the support plate 22, and with it the isolation plate 28 with the slip-rings 43 and the ring grooves 44, are rotated by the centering device 25, while the connector elements 47 and the electrically conductive sliding contacts 48 remain stationary at the base element 27. As a result, the supply lines 35′, 36′ are permanently installed in the semi-trailer 11 as a further advantage.

FIG. 3 shows the one coupling block 31 on the semi-trailer 11, at which two housing parts 60, 61 are held such as to be capable sliding against one another by guide elements 68 with centering tips 64 as centering elements, and running parallel to these are spring elements 69. These bolt-shaped guide elements 68 are held in the rear housing part 60 in each case by a securing element 71, while the front housing part 61 is positioned by means of stop elements 64′ at the rear at the centering tips 64. Arranged on both sides outside the plurality of connector elements 38 are at least one spring element 69, and on the outside in each case a guide element 68. They are arranged parallel to one another in one or more rows on a horizontal axle plane, which therefore allows for the low structural height of the coupling device. It is of course possible for the number and position of the connector elements, the spring elements, or the guide elements to be selected differently depending on the requirements.

The guide elements 68 are formed by centering tips 64, which project towards the housing part 61, which, during coupling, can be inserted into centering openings 55 in the corresponding coupling block 30 on the fifth-wheel coupling 15, such that a centering movement takes place before the connector elements 37, 38, 77, 78 are coupled. Connected to these, on the rear, are the lines or hoses configured as supply lines 23, 24. On the front side, closure caps or the like, not shown in any greater detail, can be located, which can pivot away and which, in the uncoupled state, protect these connector elements 38, 77. Moreover, in the rear housing part 60, on both sides, in each case a pressure spring 66 is accommodated, arranged transversely, which allows for a degree of play of the coupling block 31 transversely to the axle direction of the guide elements 68. Advantageously, spring elements 66′ (according to FIG. 1) are also provided in the z-direction, taking effect onto the housing part 60 of the coupling block 31, such that, at the centering of the centering tips 64 in the centering openings 55, any deviations in the y-direction and/or z-direction can be compensated for. Other spring elements can also be used instead of these pressure springs 66, 66′, 69.

In the initial state, the housing parts 60, 61, are held at a distance from one another, as shown. During the coupling procedure, according to FIG. 1, as the first action, the wedge surfaces 26′ of the centering device 25 are pressed against the flanks 17′ of the slot opening 17. This leads to the coupling blocks 30, 31, being aligned with one another and then being precisely positioned by the centering means. Next, due to the housing 30′ of the coupling block 30 moving backwards, the front housing part is moved against the rear housing part 60, 61, by means of a certain stroke movement against the pressure spring of the spring elements 69, in order thereby for the impact forces on the housing part 61 caused during the reversing of the tractor unit to be absorbed in the form of a buffer. As well as this, any tolerances in the coupled state between the fifth-wheel coupling 15 and the semi-trailer 11 can be compensated.

FIG. 4 and FIG. 5 show one of the electrical connector elements 38 contained in the housing parts 60, 61, and one of the connector elements 37 in the housing 30′ of the other coupling block 30. Preferably, the connector elements 38 in the rear housing part 60, configured as pins, are held such as to be movable under spring pressure. To the purpose, contained in a borehole 62 in the housing part 60 is a sleeve 63, guided in the borehole, and a pressure spring 64 with a stop 67 on the rear side, wherein the sleeve 63 is pressed as far as a stop surface 62′ in the borehole 62, and secured in this is the connector element 38, extending through the borehole 62 and connected on the rear side to the supply line 35. In the front housing part 61, this connector element 38 projects, in the unconnected state of the coupling blocks, as shown in FIG. 4, into the front housing part 61 which is pushed forwards, in which it is tightly enclosed. In addition, arranged at the connector element 38 is an isolating envelope 38′ between the housing parts 60, 61. As a result, these connector elements 38 are protected against the outside in the uncoupled state.

The respective corresponding connector element 37 in the housing 30′ consists of a metallic sleeve 65, an isolating envelope 72 surrounding it, a closure bolt 73 in it, and a spring 74, which presses the bolt as far as the opening 65′, in the sleeve 65, connected to which on the rear side is the supply line 35.

During connecting in accordance with FIG. 5, by pressing the housing 30′ of the other coupling block 30 against the housing part 61, the connector elements 38 are in each case pushed out of the housing part and plugged into the respective sleeve 65 with the corresponding plugging connection opening of this pressing housing, due to the housing part 61 being pushed against the stationary housing part 60. In this situation, this connector element 38 comes in contact with the closure bolt 73 located in the sleeve 65 and pushes it into a rearward position, and, due to the contact with the sleeve, electrical current can be conducted.

It can further be seen that this connector element 38, held in the rear housing part 60, and the sleeve 63 in the borehole 62 are pressed backwards against the pressure spring 64 as spring elements. As a result, tolerance differences in the coupled coupling blocks can be compensated, or jamming if the connector elements cannot be inserted into the sleeves 65.

Conversely, during uncoupling the housing 30′ is moved away from the housing part 61, and this is pressed by the spring elements 69 into the initial position according to FIG. 4, in which the connector elements 38 are again tightly located and the closure bolt 73 closes the sleeve 65 by means of the other spring 74.

FIG. 6 and FIG. 7 show one of the connector elements 78 contained in the housing parts 60, 61, and one of the connector elements 77 in the housing 30′ of the other coupling block 30. These connector elements 77, 78, differ from those according to FIG. 4 and FIG. 5 in that they are configured for the passage of a medium, such as air, gas, water, or oil. Hereinafter the differences are now presented in relation to the electrical connector elements 37, 38. The connector element 77 extending through both the housing parts 60, 61, is configured as a small tube, and is preferably held in a movable manner under spring pressure in the rear housing part 60. Contained in a borehole 83 in the housing part 60 is a pressure spring 81 and a stop 82 for this spring, wherein this connector element 77, extending through the borehole 83 and connected on the rear side to the supply line 36, is guided in this borehole.

In the front housing part 61, this connector element 77, in the unconnected state of the coupling blocks as shown in FIG. 6, projects into the front housing part 61, pushed forwards, in which it is enclosed. Advantageously, the connector element 77 is closed at the front by a cover 77′, but in this situation is provided with one or more side openings 77″, which serve as ventilation holes for the supply line 36 in the uncoupled state. As a result, these connector elements 77 are protected against the outside in the uncoupled state. The respective corresponding connector element 78 in a passage hole 84 in the housing 30′ consists of a non-return valve 75 with a spring element 79 and a connection element 86, to which the supply line 36 is connected. In the uncoupled state, the non-return valve 75 connects to the passage hole 84, as can be seen in FIG. 6.

When connecting in accordance with FIG. 7, by the pressing of the housing 30′ of the other coupling block 30 against the housing part 61, the connector elements 77 are in each case pushed out of the housing part and pushed into the respective passage hole 84 of this housing 30′ which is exerting the pressure, due to the housing part 61 being pushed against the stationary housing part 60 of the coupling block 31. In this situation, this connector element 77 pushes the non-return valve 75 into a rear position in the passage hole 84, and therefore the passage for the medium is formed through this hole into the supply line 36.

During the coupling, the non-return valve 75 is pressed by the connector element 77 as far as against a stop, as can be seen in FIG. 7. As a result, a counter-force is incurred which takes effect on the connector element 77, as a result of which a certain instability can be incurred. Due to this, in the coupled state, a certain degree of movement occurs at the connector element 77, in the housing part 60. There are hardly any relative movements between the housing part 61, the housing 30′, and the connector element 77. The ring seal 87 is therefore not closed unnecessarily. The same function principle applies to the electrical connection.

FIG. 8 shows a variant of an isolation plate 90 with slip rings 43, which can be used instead of the isolation plate 28 according to FIG. 2 in or at the base element 27 of the rotary element 20, in the shape of a pot, plate, or other configuration. Consequently, hereinafter the same reference numbers are used for the same components as for the isolation plate 28 referred to heretofore. This isolation plate 90 is characterized in that it is provided with a base plate 95, as one piece or multi-part, in ring shape or other configuration, with ring grooves 98, 99, and multi-part isolating rings 93, 94, arranged therein, with slip rings 43 or sealing elements 91, 92, accommodated therein. This base plate 95 is advantageously made of a metallic material, such as aluminium, and in the mounted state is pressed against the base element 27 by spring elements 39 held in the support plate 22, in order to ensure a permanent seal between it and the base element 27.

Embedded in each case in the ring grooves 99 are this multi-part isolation ring 93, 94, and in this in turn is a slip ring 43, coaxial to one another. These isolation rings 93, 94, are each assembled from ring segments 96, 97, arranged in rows, at a distance interval a from one another in the base plate 95, which consists of an electrically isolating material, in particular of plastic. The purpose of these respective distance intervals a is that the expansion of the plastic material, which occurs at the high temperature differentials which are possible when in operation, can take place satisfactorily without the material bending or bowing. In principle, however, these isolation rings 93, 94, can each be produced as one-part or multi-part, depending on requirements.

Provided between these isolation rings 93, 94, in the base plate 95 is a further ring groove 98, with sealing elements 91, 92, integrated into them, to allow the passage of a non-electrical medium. These sealing elements 91, 92, are configured in a ring shape, of which one extends in the ring groove 98 along the inner wall, and the other along the stepped outer wall 98′, 98″. They are preferably configured as V-shaped in cross-section, and comprise sealing lips 91′, 92′, which project outwards, and which in the assembled state are pressed as far as the opposing contact surfaces of the isolation plate 90 and of the base element 27, in order to achieve a permanent effective seal in this ring groove 98 also.

This isolation plate 90 could of course also be configured differently from the one shown. It would be possible to provide, for example, as with the isolation plate 28, three or even more slip rings 43 arranged coaxially to one another, and also more than one ring groove 98, for example at least one provided on the inside and outside of the slip rings. Theoretically, it would also be possible for only one ring groove to be provided, or only one in each case with each slip ring and a pair of sealing elements.

The invention has been adequately explained by the exemplary embodiments presented. Other variants could of course also be described.

The coupling blocks 30, 31, on the tractor unit and/or the semi-trailer are mounted spring-loaded in the x-, y-, z-direction and/or in their angle of rotation in relation to one another, such that any dimensional deviations of their positions to one another occurring during the coupling of the tractor unit to the semi-trailer can be compensated.

In order to save space, the connector elements of the coupling blocks are arranged approximately parallel to one another, in one or more rows as necessary, beneath the support surface of the fifth-wheel coupling or of the support element of the semi-trailer.

In principle, it would be possible for the coupling blocks to be arranged next to the fifth-wheel coupling and the support element instead of beneath them, and it would also be possible for a coupling block to be arranged on both sides of them, which would be capable of being coupled in pairs.

The rotary element can of course also be configured differently. It would be possible, for example, for only one fixed isolation plate to be present in the base element, and beneath this a rotatable plate with the slip-ring contacts and the connecting parts, or the base element could be mounted such as to rotate with the slip-ring packet inside it, wherein the sliding contacts and the connector elements would have to be held separately in the semi-trailer.

The coupling blocks and the centering means assigned to them could also be placed the other way round, i.e. that on the fifth-wheel coupling could be arranged on the support element, and the one corresponding to it could be arranged on the fifth-wheel coupling.

Moreover, the connector elements could be arranged in a simplified manner in the coupling blocks, for example with the bearings providing spring support being removed, and they then being secured in a fixed position in the respective housing part.

In order to save space, the connector elements of the coupling blocks are arranged approximately parallel to one another, in one or more rows as required, beneath the contact surface of the fifth-wheel coupling or the support element of the semi-trailer.

The connector elements 77 in the housing 60 for the passage of a medium, such as air, gas, water, or oil, could additionally each contain a non-return valve, in order for the medium to be reliably sealed in the uncoupled state as the pressure in the line 36 increases.

1. Coupling device for supply lines, in particular for conveying media from a tractor to a semi-trailer (11) or vice-versa, which can be coupled or uncoupled by means of a coupling unit (10), which comprises a fifth-wheel coupling (15) on the tractor and a support element (22′) with a kingpin (21) on the semi-trailer (11), characterized in that arranged on the under side of the fifth-wheel coupling (15) and the king pin (21) and/or next to them is at least one coupling block (30, 31), which in each case are provided with preferably a plurality of connector elements (37, 38, 77, 78) for connecting the supply lines (33, 34, 35, 36), wherein a rotary element (20) is provided arranged in the support element (22′), secured to which are the at least one coupling block (30, 31) and a centering device (25), which during coupling interact with centering means on the fifth-wheel coupling (15) in such a way that the coupling blocks (30, 31) can be aligned with one another and subsequently connected, wherein the supply lines (35, 36) leading away from the coupling block (31) on the semi-trailer (11) are guided through connecting means (23, 24) in the rotary element (20) to the supply lines (35′, 36′) arranged in the semi-trailer (11).

2. Coupling device according to claim 1, characterized in that this centering device (25) is secured to the support element (22′), and beneath it the coupling block (31), wherein the supply lines (35, 36) are guided from the coupling block (31) through the centering device (25) into the rotary element (20), and from that into the semi-trailer (11).

3. Coupling device according to claim 1, wherein the rotary element comprises at least one base element secured in the semi-trailer, and a slip-ring packet mounted in that element, as connecting means, which connect the supply lines of the tractor unit with those in the semi-trailer such as to transfer energy.

4. Coupling device according to claim 3, characterized in that the slip-ring packet (29) preferably comprises a plurality of slip-rings (43) and/or ring grooves arranged coaxially at a distance from one another, with connections (45, 46) on the inlet side to the supply lines (35, 36) leading away from the coupling block (31), while sliding contacts (48) and/or connector elements (47) are assigned to the base element (27), which are in contact with the slip rings (43) or the ring grooves and connected to these are the supply lines (35, 36) in the semi-trailer (11).

5. Coupling device according to claim 3, wherein arranged in the base element of the rotary element are an isolation plate which is at least partially not electrically conductive, with the slip-ring packet a stabilizing plate or base plate and a lower support plate with at least one spring element rotatably mounted in between, which run coaxially to one another and arranged in the center is the king pin (21) secured to the base element

6. Coupling device according to claim 1, wherein the centering device, located on the support plate with the support element, and the fifth-wheel coupling is configured with its slot opening in the plate for the king pin, is formed in each case with wedge-shaped centering means, by means of which the centering device is aligned during coupling in the longitudinal direction of the slot opening, and, depending on its position, can be positioned by a rotational adjustment about the king pin, wherein, with the centering device, the support plate is rotated, and with it the isolation plate with the slip-ring packet, while the sliding contacts and connection elements remain stationary in the base element.

7. Coupling device according to claim 6, characterized in that the wedge-shaped centering means (26) of the centering device (25) is formed with two front-side wedge elements, which can be adjusted by at least one guide element (54) radially to the direction of rotation, and by means of at least one spring element (56) are pressed into a front end position, while the slot opening (17) of the fifth wheel coupling (15) on the inlet side is formed with corresponding wedge surfaces (26′), with which, in the coupled state, when the king pin (21) strikes against the end side in the slot opening (17), the wedge elements come in contact due to the pressure from the at least one spring element (56), such that the centering device (25) is positioned in the fifth wheel coupling (15) such that it cannot rotate.

8. Coupling device according to claim 1, wherein the coupling blocks comprise in each case a housing or housing parts with a plurality of connector elements inside them, for connecting the supply lines wherein at least one centering element is assigned in each case to the corresponding coupling blocks which, during the connecting procedure, first causes a centering movement and then the insertion of the connector elements.

9. Device according to claim 8, characterized in that the housing parts (60, 61) of the one coupling block (31) are held by at least one guide element (68) and running parallel to it at least one spring element (69), such that they can be displaced in relation to one another, wherein the at least one guide element (68) is secured in each case in the rear housing part (60), and the front housing part (61), in the unconnected state, is pushed forwards as far as a stop (64′).

10. Device according to claim 9, characterized in that during the connecting of the coupling blocks (30, 31), the front housing part (61) of the housing (30′) of the other coupling block (30) can be pushed against the rear housing part (60) at least as far as into the coupled position.

11. Device according to claim 10, characterized in that the longitudinal connector elements (38), held in the rear housing part (60) in the unconnected state of the coupling blocks, are tightly enclosed by the housing part (61) pushed forwards, while during connecting, due to the pressure of the other coupling block (30), they are pushed out of the housing part (61) and pushed into matching connecting openings of this coupling block (30) imposing the pressure.

12. Device according to claim 8, wherein the longitudinal connector elements, held in the rear housing part are pressed by means of a spring element against a front stop surface, and, during coupling, can be moved backwards against the spring force by means of a stroke movement in their longitudinal direction, in order for any tolerances or blockages to be compensated.

13. Device according to claim 8, wherein the longitudinal connector elements, held in the rear housing part are formed in each case as electrically conductive metal pins or as small tubes for the passage of a medium, while integrated in the other coupling block are corresponding plug openings, as electrically conductive sleeves, which accommodate the metal pins approximately free of any play, or formed as non-return valves for the passage of the respective medium.

14. Device according to claim 8, wherein the centering element is formed as two centering tips at the guide elements of the one coupling block, which, during coupling, can be pushed into centering openings in the corresponding coupling block, such that this centering process takes place before the connector elements are coupled.

15. Device according to claim 1, wherein the coupling blocks on the semi-trailer and/or the tractor unit are mounted spring-loaded in the x-, y-, z-direction and/or in their angle of rotation in relation to one another, such that any dimensional deviations in the coupling positions in relation to one another occurring during the coupling of the tractor unit to the semi-trailer can be compensated.

16. Device according to claim 1, wherein the media to be conveyed are electrical energy or electrical signals, or pneumatic and/or hydraulic energy or signals, which are transferred from the tractor unit to the semi-trailer or vice-versa.

17. Rotary element, for a coupling device according to claim 1, wherein the rotary element comprises at least one base element secured in a semi-trailer, and a slip ring packet mounted in that element, by means of which supply lines can be connected to transfer energy to consuming components in the semi-trailer.

18. Rotary element according to claim 17, characterized in that the slip ring packet (29) preferably comprises a plurality of slip rings (43) and/or ring grooves (44), arranged coaxially at a distance from one another, with connections (45, 46) to the supply lines (35, 36) on the inlet side, while slide contacts (48) and connector elements (47) are assigned to the base element (27), which are in contact with the slip rings (43) or ring grooves and connected to these are the supply lines (35, 36, 35′, 36′) in the semi-trailer (11).

19. Rotary element according to claim 17, further comprising an isolation plate located in or at the base element, which is pot-shaped, plate-shaped, or of another shape, which is formed from a one-part or multi-part base plate ring shaped or of another shape, with a plurality of ring grooves, and arranged in this are one-part or multi-part isolation rings with sealing elements arranged in the slip rings accommodated in these isolation rings and/or in the ring grooves.

20. Rotary element according to claim 19, characterized in that the base plate (95) of the isolation plate (90) are made of a metal, and the isolation rings (93, 94) in the plate are composed in each case of ring segments (96, 97) arranged next to one another in rows and at a distance (a) from one another.

21. Rotary element according to claim 19, wherein of the sealing elements in the base plate, one runs along the inner wall and the other along the outer wall in the ring groove, and they are provided in each case with a sealing lip projecting outwards, which in the assembled state are pushed in as far as the opposing contact surfaces of the isolation plate and of the base element.
